(19) United States
(12) Patent Application Publication
(10) Pub. No.: US 2013/0329217 A1
(43) Pub. Date: Dec. 12, 2013

(54) Laser System for Aligning a Bed Transport Mechanism in an Imaging System

(71) Applicants: Shikui Yan, Knoxville, TN (US); Thomas Bruckbauer, Knoxville, TN (US); Travis Pless, Lenoir City, TN (US); Robert Scott Beach, Knoxville, TN (US); Sam Griffin, New Taxewell, TN (US)

(72) Inventors: Shikui Yan, Knoxville, TN (US); Thomas Bruckbauer, Knoxville, TN (US); Travis Pless, Lenoir City, TN (US); Robert Scott Beach, Knoxville, TN (US); Sam Griffin, New Taxewell, TN (US)

(73) Assignee: SIEMENS MEDICAL SOLUTIONS USA, INC., Malvern, PA (US)

(21) Appl. No.: 13/493,083

(22) Filed: Jun. 11, 2012

(51) Int. Cl. G01B 11/14; G01B 11/26

(52) U.S. Cl. 356/138; 356/400

(57) ABSTRACT

A system for aligning a bed of an imaging system with an imaging plane. The system includes a laser device which generates a laser beam and a target element having a target detecting surface. The system also includes a reflective element which receives the laser beam. The reflective element includes a reflective detecting surface for detecting a first position of the laser beam. A first parameter of the bed is adjusted until the laser beam is positioned on a first center portion of the reflective detecting surface. In addition, the laser beam is reflected to the target detecting surface to detect a second position of the laser beam. A second parameter of the bed is adjusted until the laser beam is positioned on a second center portion of the target detecting surface to orient the bed substantially perpendicular to the imaging plane.

### FIELD OF THE INVENTION

This invention relates to a system and method for aligning a transport mechanism for moving a bed, table, or imaging device in an imaging system having an imaging plane, and more particularly, to a laser system having a target element and a reflective element for detecting the position of a laser beam wherein a position of the bed is adjusted based on detected laser beam positions.

### BACKGROUND OF THE INVENTION

It is important that a bed used to accommodate or hold an object to be scanned by an imaging system be correctly aligned with an imaging plane of the system so that accurate long-axial field of view (FOV) scans are obtained. In a computed tomography (CT) imaging system 100, for example, a gantry 10 (see FIG. 1) is used that includes a central bore or tunnel 12 for receiving a device for holding an object to be scanned, such as a table or bed 14. The bed 14 is supported by first 16 and second 18 bed stages to enable horizontal and vertical positional adjustments, respectively, of the bed 14. The gantry 10 also includes an X-ray source 22 and a detector 24 that are positioned opposite each other to form an imaging plane 20 which coincides with the tunnel 12. In operation, a transport mechanism 21 moves the bed 14 along the Z-axis (see arrow 11) toward the imaging plane 20. The X-ray source 22 and detector 24 rotate about the bed 14 to generate images of an object located on the bed 14, such as a patient, as part of an imaging procedure.

The bed 14 in the imaging system 100 is aligned relative to X, Y, and Z translation directions and pitch 15, yaw 17 and roll 19 rotation angles about three perpendicular axes. In many imaging systems, a manual multi-step procedure is used wherein a bed alignment tool, protractor, machinist square and other tools or devices are used to align the bed 14. In this procedure, specific parameters for bed alignment are manually checked, and if the bed 14 is not aligned, adjustments are made to align the bed 14 whereupon bed alignment is then rechecked. The process of checking bed alignment, making adjustments to the alignment and rechecking the alignment is then repeated until a desired alignment is achieved. However, this results in an iterative process which is time consuming and takes experienced personnel approximately six hours to complete.

### SUMMARY OF THE INVENTION

A system for aligning a bed of an imaging system with an imaging plane is disclosed. The system includes a laser device which generates a laser beam and a target element having a target detecting surface and a collimator hole, wherein the laser beam is transmitted through the collimator hole. The system also includes a reflective element which receives the laser beam. The reflective element includes a reflective detecting surface for detecting a first position of the laser beam wherein at least one first parameter of the bed is adjusted until the laser beam is positioned on a first center portion of the reflective detecting surface. In addition, the laser beam is reflected to the target detecting surface to detect a second position of the laser beam wherein at least one second parameter of the bed is adjusted until the laser beam is positioned on a second center portion of the target detecting surface to orient the bed substantially perpendicular to the imaging plane.

### BRIEF DESCRIPTION OF THE DRAWINGS

FIG. 1 depicts a gantry and bed arrangement for an imaging system.

FIG. 2 depicts a schematic of a laser system for aligning a bed of an imaging system in accordance with the invention.

FIGS. 2A-2B depict first and second cross hair patterns formed on reflective and target elements, respectively of the system.

FIG. 3 illustrates a calibration flow diagram for aligning the bed with the image plane of the imaging system.

### DESCRIPTION OF THE INVENTION

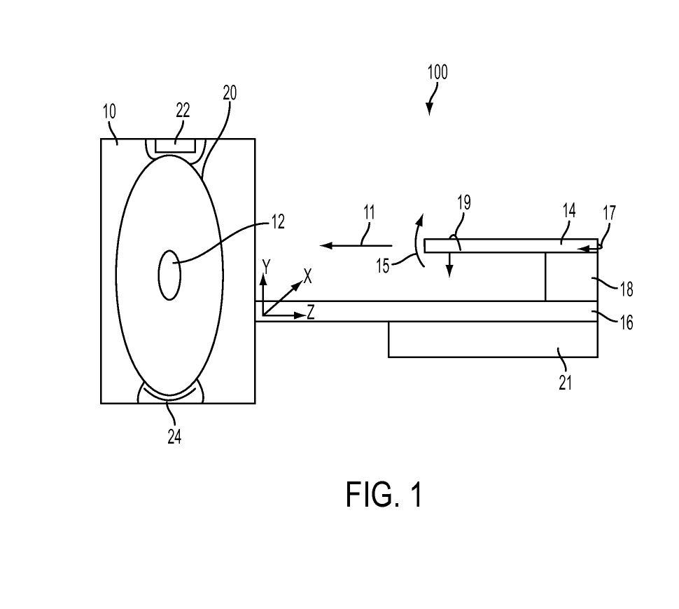

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings. In the description below, like reference numerals and labels are used to describe the same, similar or corresponding parts in the several views of FIGS. 1-4.

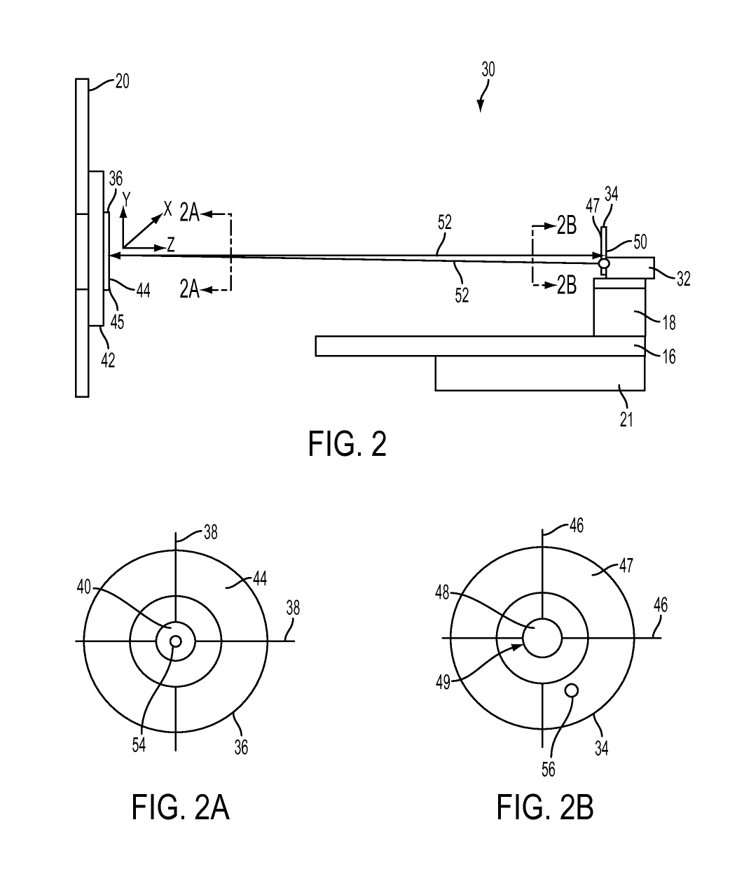

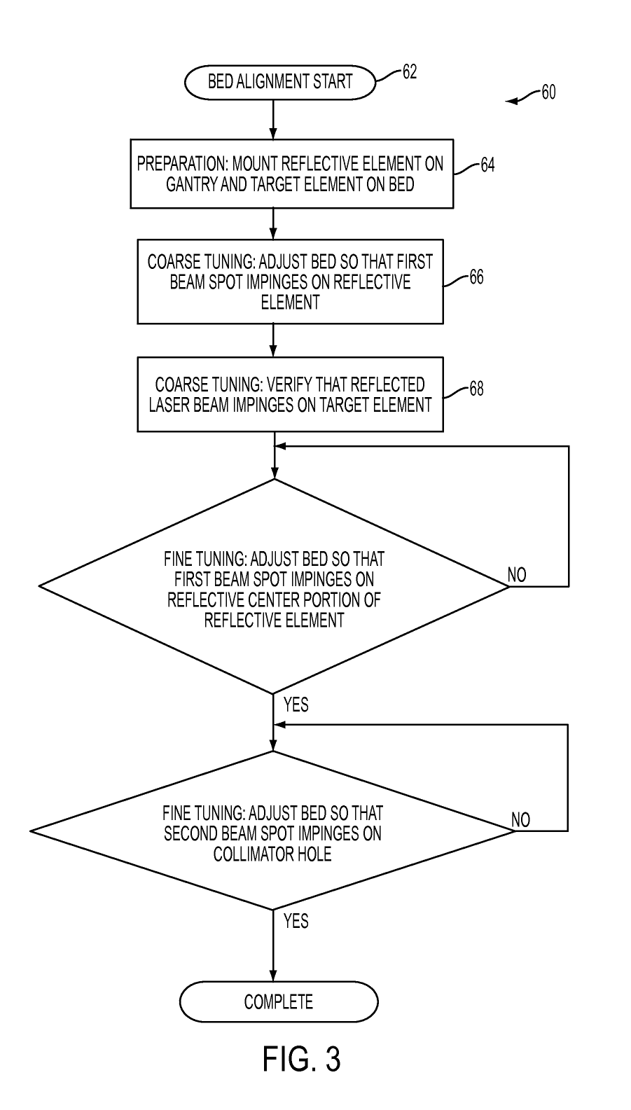

Referring to FIG. 2, a schematic of a laser system 30 for aligning the bed 14 of an imaging system in accordance with the invention is shown. The system 30 may be used in connection with the CT imaging system 100, for example, or any other imaging system or scanner having an imaging plane that is oriented substantially perpendicular to a bed 14. In addition, the imaging system may of the type having a movable bed and a stationary imaging device or a stationary bed and a movable imaging device and combinations thereof. Further, the system 30 may be used in clinical imaging systems and systems having a higher resolution such as preclinical imaging systems including the Siemens Inveon CT imaging system. The system 30 includes a laser device 32 that is removably mounted on the second bed stage 18 and a target element 34 removably mounted on the second bed stage 18 in front of the laser device 32. The system 30 also includes a reflective element 36 having a first surface 44. Referring to FIG. 2A, a front view of the reflective element 36 along view line 2A-2A of FIG. 2 is shown. The first surface 44 includes a first cross hair pattern 38 having a reflective center portion 40. In one embodiment, the reflective center portion 40 is approximately 3 mm in size. Referring back to FIG. 2, the reflective element 36 is attached to a mounting fixture 42 by bonding, for example. The mounting fixture 42 is removably attached to the gantry 10 such that a plane 45 of the first surface 44 is substantially parallel to the imaging plane 20.

FIG. 2B is a front view of the target element 34 along view line 2B-2B of FIG. 2. The target element 34 includes a second surface 47 having a second cross hair pattern 46 and a collimation hole 48 located in a center portion 49 of the second cross hair pattern 46. In one embodiment, the collimation hole 48 is approximately 1 mm in size. The first 38 and second 46 cross hair patterns may each include indicia to enable measurement of the location of a laser beam spot formed on the first 44 and second 47 surfaces. Alternatively, the first 44 and second 47 surfaces each include light sensitive material or device for detecting a location of a laser beam spot on the surfaces 44,47. The first 44 and second 47 surfaces face each other and may be spaced approximately 100 cm from each other. Alternatively, other predetermined patterns, such as bullseye and other patterns, may be formed on the first 44 and second 47 surfaces instead of the first 38 and second 46 cross hair patterns.

In accordance with the invention, a laser beam 50 generated by the laser device 32 is first aligned with the Z-axis. The laser beam is then transmitted through the collimation hole 48 to form a collimated laser beam 52. The collimated laser beam 52 then impinges on the reflective center portion 40 and forms a first beam spot 54 on the first surface 44. If the first beam spot 54 is not located on the reflective center portion 40, an offset is indicated in either or both the X and Y directions, depending on the location of the first beam spot 54. The offset is measured by using the first cross hair pattern 38. Using the measured offset, the bed 14 is then correspondingly adjusted in either the X direction or the Y direction, or both the X and Y directions, as needed, so that the first beam spot 54 impinges on the reflective center portion 40 as shown in FIG. 2A.

The laser beam 52 is then reflected by the reflective center portion 40 back to the target element 34 thus forming a second beam spot 56 on the second surface 47. If the second beam spot 56 is not located on the center portion 49 of the second cross hair pattern 46, as offset is indicated. The bed 14 is then correspondingly adjusted so that the second beam spot 56 impinges on the center portion 49. This ensures that the bed axis (i.e. the Z axis) and the first surface 44 are substantially perpendicular to each other thus adjusting pitch and yaw rotation angles to zero. The second beam spot 56 then coincides with the collimation hole 48. In one embodiment, the laser device 32 utilizes a non-amplified, light emitting diode (LED) based laser source such that the laser beam 50 is not affected by the back reflection into the collimator hole 48. Further, adjustment of the second beam spot 56 may be performed dynamically by tracking the position of the second beam spot 56 on the second surface 47 as the bed 14 moves.

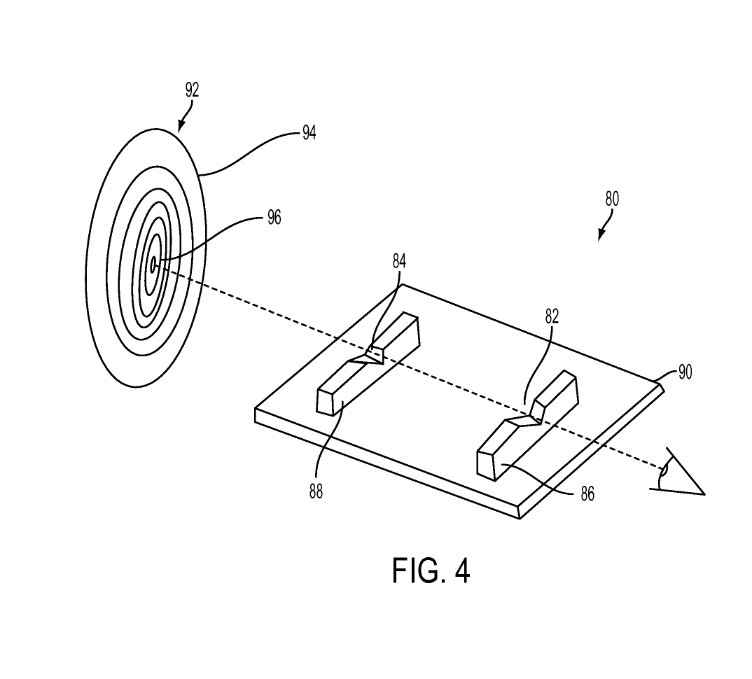

Referring to FIG. 3, a calibration flow diagram 60 for the current invention is shown. The bed alignment process begins at step 62 and proceeds to step 64 wherein the reflective element 36 is mounted on the gantry 10 and the target element 34 is mounted on the bed 14. At step 66, a coarse adjustment of the bed 14 is performed to ensure that the first beam spot 54 impinges on the reflective element 36. At step 68, a coarse adjustment of the bed 14 is performed to ensure that the second beam spot 56 impinges on the target element 34. At step 66, a determination is made as to whether the first beam spot 54 impinges on the reflective center portion 40 of the reflective element 36. If the first beam spot 54 does not impinge on the reflective center portion 40, a fine adjustment of the bed 14 is performed. Once the first beam spot 54 impinges on the reflective center portion 40, the process moves to step 70 wherein a determination is made as to whether the second beam spot 56 impinges on the collimator hole 48. If the second beam spot 54 does not impinge on the collimator hole 48, a fine adjustment of the bed 14 is performed. Once the second beam spot 54 impinges on the collimator hole 48, the calibration process is complete at step 70.

Use of the invention results in a bed alignment process that is faster, more accurate and more reliable. In particular, the system 30 has resulted in a reduction of the time needed to align the bed 14 from approximately six hours to approximately five minutes. Further, tests have shown that the system 30 reduces measurement error by approximately one half. In addition, accuracy is improved to approximately ±0.031 degrees from approximately ±0.15 degrees.

Therefore, the system 30 provides a collimated, double targeted, reflective (CTDR) laser system for enabling alignment of a bed used in a medical imaging system. The CDTR system is relatively low cost and easy to assemble. In addition, the system 30 provides instant feedback during use since the location of second beam spot 56 on the second surface 47 of the target element 34 is readily observable as the bed 14 is moving. Further, the CDTR system enables the calibration of five degrees of freedom (i.e. translation X and Y directions and pitch, yaw and roll rotations if double sources are used) using a single apparatus.

Referring to FIG. 4, a schematic of an alternate embodiment of the invention is shown. In this embodiment, the laser device 32 is replaced by an optical alignment device 80. The device 80 includes first 82 and second 84 substantially V-shaped grooves formed in first 86 and second 88 support blocks that are mounted to an attachment plate 90. The attachment plate 90 is removably mounted to the bed 14 such that the first 82 and second 84 grooves are aligned with the Z-axis of the imaging system 100. In addition, an alignment plate 92 is removably attached to the gantry 10. The alignment plate 92 includes a predetermined pattern with indicia, such as a crosshair or bullseye 94 pattern used to align the bed 14. In order to align the bed 14, an operator establishes a line of sight through the first 82 and second 84 grooves to determine whether the bed 14 is aligned. If a center portion 96 of the bullseye pattern 94 is visible through the first 82 and second 84 grooves, the bed 14 is aligned. If the center portion 96 is not visible, the bed 14 is adjusted until the center portion 96 of the bullseye pattern 94 is visible through the first 82 and second 84 grooves. In yet another embodiment, an aperture hole may be used instead of the first 82 and second 84 grooves to view the bullseye pattern 94.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations.

What is claimed is:

1. A system for aligning a bed of an imaging system with an imaging plane, comprising:
a laser device which generates a laser beam;
a target element having a target detecting surface and a collimator hole, wherein the laser beam is transmitted through the collimator hole; and
a reflective element which receives the laser beam, the reflective element having a reflective detecting surface for detecting a first position of the laser beam wherein the first position is used to adjust at least one first parameter of the bed and wherein the laser beam is reflected to the target detecting surface to detect a second position of the laser beam wherein the second position is used to adjust at least one second parameter of the bed.

2. The system according to claim 1, wherein the reflecting and target detecting surfaces each include a predetermined pattern for detecting the first and second positions, respectively, of the laser beam.

3. The system according to claim 1, wherein the reflective and target detecting surfaces each include a cross hair pattern for detecting the first and second positions, respectively, of the laser beam.

4. The system according to claim 1, wherein the reflective and target detecting surfaces each include light sensitive material or device for detecting the first and second positions, respectively, of the laser beam.

5. The system according to claim 1, wherein adjustment of at least one first parameter of the bed includes X and Y positions.

6. The system according to claim 1, wherein adjustment of at least one second parameter of the bed includes pitch and yaw rotation positions.

7. The system according to claim 1, wherein laser device utilizes a non-amplified, light emitting diode (LED) laser source.

8. The system according to claim 1, wherein the imaging system is a computed tomography imaging system.

9. The system according to claim 1, wherein the target element is mounted to the bed and the reflective element is mounted to a gantry of the imaging system wherein the reflective detecting surface is oriented substantially parallel to the imaging plane.

10. A system for aligning a bed of an imaging system with an imaging plane, comprising:
a laser device which generates a laser beam;
a target element having a target detecting surface and a collimator hole, wherein the laser beam is transmitted through the collimator hole; and
a reflective element which receives the laser beam, the reflective element having a reflective detecting surface for detecting a first position of the laser beam wherein at least one first parameter of the bed is adjusted until the laser beam is positioned on a first center portion of the reflective detecting surface and wherein the laser beam is reflected to the target detecting surface to detect a second position of the laser beam wherein at least one second parameter of the bed is adjusted until the laser beam is positioned on a second center portion of the target detecting surface to orient the bed substantially perpendicular to the imaging plane.

11. The system according to claim 10, wherein the first center portion is approximately 3 mm in size.

12. The system according to claim 10, wherein the second center portion is approximately 1 mm in size.

13. The system according to claim 10, wherein the reflecting and target detecting surfaces each include a predetermined pattern for detecting the first and second positions, respectively, of the laser beam.

14. The system according to claim 10, wherein the reflective and target detecting surfaces each include a cross hair pattern for detecting the first and second positions, respectively, of the laser beam.

15. The system according to claim 10, wherein the reflective and target detecting surfaces each include light sensitive material or device for detecting the first and second positions, respectively, of the laser beam.

16. The system according to claim 10, wherein adjustment of at least one first parameter of the bed includes X and Y positions.

17. The system according to claim 10, wherein adjustment of at least one second parameter of the bed includes pitch and yaw rotation positions.

18. The system according to claim 10, wherein the target element is mounted to the bed and the reflective element is mounted to a gantry of the imaging system wherein the reflective detecting surface is oriented substantially parallel to the imaging plane.

19. The system according to claim 10, wherein laser device utilizes a non-amplified, light emitting diode (LED) laser source.

20. A method for aligning a bed of an imaging system with an imaging plane, comprising:
generating a laser beam;
detecting a first position of the laser beam on a reflective detecting surface;
adjusting at least one first parameter of the bed until the laser beam is positioned on a first center portion of the reflective detecting surface;
detecting a second position of the laser beam on a target detecting surface; and
adjusting at least one second parameter of the bed until the laser beam is positioned on a second center portion of the target detecting surface to orient the bed substantially perpendicular to the imaging plane.
